(19) United States
(12) Patent Application Publication
(10) Pub. No.: US 2009/0064652 A1
(43) Pub. Date: Mar. 12, 2009

(54) METHOD OF MAKING BUSHING WITH BLIND GROOVES USED AS OIL RESERVOIR FOR CHAIN

(76) Inventor: Hirofumi Miki, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/187,417

(22) Filed: Aug. 7, 2008

(30) Foreign Application Priority Data
Sep. 11, 2007 (JP) 2007-234927

(51) Int. Cl. B21L 9/00; F16G 15/00

(52) U.S. Cl. 59/8; 474/91

(57) ABSTRACT

A method of making a bushing 100 with blind grooves used as oil reservoirs for a chain, by which a number of blind grooves 112 for oil reservoirs are provided in an axial direction on an inner circumferential surface of a cylindrical steel member in forging processes comprises the steps of: fitting one end of a cylindrical steel member 106 to blind groove forming protrusions HP1 of a hollow die pin HP contained in a blind groove forming die D6, pressing the blind groove forming protrusions HP1 against an inner circumferential surface of the cylindrical steel member 106 while a diameter widening center pin EP inserted from the other end to the one end of the cylindrical steel member 106 is abutted and held on a front end inner circumferential portion HP3 of the hollow die pin HP and pushing a blind groove forming punch P6 into the blind groove forming die D6 while pressing the other end of the cylindrical steel member 106 and sliding an inner circumferential surface 111 of the cylindrical steel member 106 with respect to blind groove forming protrusions HP1.

### FIELD OF THE INVENTION

The present invention relates to a bushing for a chain, which is preferably used as a bushing, which journals a connecting pin for a chain, and particularly it relates to a method of making a bushing with blind grooves used as oil reservoirs for a chain, in which a plurality of blind grooves, which function as oil reservoirs for a lubricating oil, are formed in an axial direction on an inner circumferential surface of the bushing, i.e. in the direction of a bus line.

### BACKGROUND OF THE INVENTION

A cylindrical bearing has been used as a bearing body for a rotating shaft and a sliding bearing for a bushing or the like in a chain by inserting the rotating shaft such as a shaft, a pin or the like inside the inner circumferential surface of the bushing.

In such a cylindrical bearing a number of bottomed grooves (blind grooves) serving as oil reservoirs, are parallel to the axial direction of the inner circumferential surface to improve the lubricity between an inner circumferential surface of the bushing as the bearing surface and a shaft, a pin or the like.

A conventional method of making such a cylindrical bearing uses a die pin HP having a hollow segmented end provided with plurality of blind groove forming projections. A center pin EP provided concentrically on a blind groove forming punch P6 engages within an end portion of a cylindrical steel member 506 as shown in FIGS. 11 and 12.

The cylindrical steel member 506 is thus pressed into the cylindrical die D6 between the wall of the die and the hollow-ended die pin therein by a diameter widening center pin EP of the punch P6 as shown in FIG. 12(a). When the blind groove forming punch P6 is advanced, the end portion of the cylindrical steel member 506 abuts on the blind groove forming punch P6 to be advanced so that the cylindrical steel member 506 is pushed into the blind groove forming cylindrical die D6. The hollow-ended die pin HP, which is fixedly disposed inside the blind groove forming cylindrical die D6, enters into the inside of the cylindrical steel member as shown in FIG. 12(b). Further, the diameter widening center pin EP provided in the blind groove forming punch P6 is pushed into a hollow end portion of the die pin HP in accordance with the advance of the blind groove forming punch P6 to diameter-widen the hollow die pin HP to displace the segments of the hollow end portion radially outward, so that groove forming projections HP1 are pressed onto the inner circumferential surface of the cylindrical steel member 506.

When the blind groove forming punch P6 is advanced, the cylindrical steel member 506 advances while inserting the hollow die pin HP in a state where the diameter widening center pin EP is pushed into the hollow end of the pin HP which causes it to be diameter-widened as shown in FIG. 12(c). Then the groove forming projections HP1, which are pressed into the inner circumferential surface of the cylindrical steel member 506, are relatively slid with respect to the cylindrical steel member 506 so that blind grooves each having a semicircular cross section are provided along the axial direction of the cylinder 506, with the result that blind groove forming is performed.

After that when the above-described blind groove forming punch P6 is retracted, the diameter widening center pin EP is also retracted from the cylindrical steel member 506 and the hollow end of the die pin HP, returning it to an original state, as shown in FIG. 12(d). Then as shown in FIG. 12(e), when a stripper S6 is advanced, the cylindrical steel member 506 is ejected from the blind groove forming cylindrical die D6 and the hollow die pin HP, in other words, the hollow die pin HP is relatively removed from the cylindrical steel member 506 whereby a cylindrical bearing 507 with blind grooves for oil reservoirs provided on the inner circumferential surface 511 is obtained. (see Japanese Laid-Open Patent Publication No. 2005-330997, pages 4 and 5, and FIGS. 8 and 9)

### Problems to be Solved by the Invention

However, in the conventional making method, there was a problem that since, when the blind grooves 512 for oil reservoirs are provided, the diameter widening center pin EP and the hollow-ended die pin HP are slid with respect to each other by strong pressing force, the wear life of the hollow die pin HP is remarkably reduced.

Further, metal fatigue of the die pin segments due to repeated diameter widening is generated during manufacture. However, there was a problem that since the hollow portion through which the diameter widening center pin EP is passed is an indispensable shape, it is difficult to increase the strength of the hollow die pin HP.

On the other hand, there was a problem that since the diameter widening center pin EP is advanced into the hollow portion of the hollow die pin HP, the outer diameter of the diameter widening center pin EP must be reduced, the diameter widening center pin EP is often broken.

Accordingly, the problems to be solved by the present invention, that is the object of the present invention is to solve the above-described prior art problems or to provide a method of making a bushing with blind grooves used as oil reservoirs for a chain, in which long-time wear damages of a diameter widening center pin and a hollow die pin for forming blind grooves for oil reservoirs are suppressed so that excellent fatigue strength can be exhibited and blind grooves for oil reservoirs can be provided with high accuracy even in a thin wall cylindrical steel member.

### SUMMARY OF THE INVENTION

The invention solves the above-described problems by a method of making a bushing with blind grooves used as oil reservoirs for a chain, by which a plurality of blind grooves for oil reservoirs are formed on an inner circumferential surface of a cylindrical steel member in an axial direction by forging steps using at least a hollow die pin including a number of blind groove forming projections on a front end outer circumferential portion and provided with a plurality of diameter widening slits along an axial direction of the pin, a diameter widening center pin, which diameter-widens a front end outer circumferential portion of said hollow die pin, a blind groove forming punch concentrically loosely fitted to said diameter widening center pin, which relatively slides in the axial direction of the pin, and a blind groove forming die, which receives said blind groove forming punch. The diameter widening slits provide a plurality of radially-displaceable segments. The method engages the proximal end of said cylindrical steel member over blind groove forming projections on the radially displaceable segments on the hollow-ended die pin in said blind groove forming die; presses the blind groove forming projections of said hollow die pin against an inner circumferential surface of the cylindrical steel member while said diameter widening center pin is inserted from the distal end of the steel member into the proximal end of said cylindrical steel member which surrounds the front end inner circumferential portion of said hollow die pin, so as to be held in an abutted state; and then forming a number of blind grooves for oil reservoirs after the blind groove forming punch surrounding said diameter widening center pin engages the distal end of the cylindrical steel member and pushes the member into said blind groove forming die, causing the inner circumferential surface of said cylindrical steel member to slide past the blind groove forming projections of the hollow die pin, thereby forming the grooves.

The method of making a bushing with blind grooves used as oil reservoirs for a chain according to a second feature of the invention solves the above-described problems by that, in addition, said diameter widening center pin includes a die pin engaging convex portion inserted into the hollow front end of said die pin in a wedge shape to be displace the segments radially outward and cause the projections on said hollow die pin to dig into the interior surface of the cylindrical steel member.

The method of making a bushing with blind grooves used as oil reservoir for a chain according to a third feature of the invention further solves the above-described problems by that, in addition to the features discussed above, a first extruding means is provided at a rear end portion of said diameter widening center pin, to press the diameter widening center pin toward a front end inner circumferential portion of the hollow die pin, and into the diameter widening center pin and also a second extracting means to slide relative to said cylindrical steel member to create grooves extending toward the distal end.

### EFFECTS OF THE INVENTION

According to the present invention, a plurality of blind grooves for oil reservoirs are formed on an inner circumferential surface of a cylindrical steel member in an axial direction by forging steps using a die pin having at least a hollow end including a number of blind groove forming projections on a front end outer circumferential portion and provided with a plurality of diameter widening slits along an axial direction of the pin, and a diameter widening center pin, which diameter-widens a hollow front end outer circumferential portion of the die pin. A blind groove forming punch concentrically loosely fitted to the diameter widening center pin relatively slides in the axial direction of the pin. A blind groove forming die receives the blind groove forming punch. The bushing blind grooves are used as oil reservoirs for a chain and the bushing preferably serves as a journal for a connecting pin of the chain. The following peculiar effects can be obtained.

The method of making a bushing with blind grooves used as oil reservoirs for a chain comprises the steps of fitting one end of the cylindrical steel member to blind groove forming projections of the hollow die pin contained in the blind groove forming die, pressing the blind groove forming projections of the hollow die pin against an inner circumferential surface of the cylindrical steel member while the diameter widening center pin inserted from the other end to the one end of the cylindrical steel member is inserted to a front end inner circumferential portion of the hollow die pin to be held in an abutted state, and then forming a number of blind grooves for oil reservoirs while a blind groove forming punch loosely fitted onto the diameter widening center pin is pushed into the blind groove forming die with the other end of the cylindrical steel member pressed and sliding an inner circumferential surface of the cylindrical steel member with respect to the blind groove forming projections of the hollow die pin. Thus when blind grooves for oil reservoirs are provided on an inner circumferential surface of the cylindrical steel member, the diameter widening center pin and the hollow die pin are not relatively slid unlike the conventional case and the diameter widening center pin is inserted into a front end inner circumferential portion of the hollow die pin and is held in an abutted state. Therefore, long-time wear damages of the diameter widening center pin and the hollow die pin are suppressed so that excellent fatigue strength can be exhibited and blind grooves for oil reservoirs can be provided with high accuracy.

Further, according to the invention, since the diameter widening center pin includes a die pin engaging convex portion inserted into a front end inner circumferential portion of the hollow die pin in a wedge shape to be abutment engaged, the diameter widening center pin diameter-widening said hollow die pin, in addition to the effects obtained by the method of making a bushing with blind grooves used as oil reservoirs for a chain, the diameter widening center pin is inserted as a wedge so that diameter widening force upon the diameter widening of the front end inner circumferential portion of the hollow die pin is remarkably reduced and a front end inner circumferential portion of the hollow die pin is reliably held in an abutted state while the front end inner circumferential portion is diameter-widened. Thus, since severe metal fatigue due to a diameter widening operation, which is repeated in the entire area of hollow portions of the hollow die pin as in a conventional case, can be avoided and the diameter widening center pin and the hollow die pin each have higher strength and a pin shape of a larger diameter than the conventional case, long lives of the diameter widening center pin and the die pin can be attained.

In addition, according to the invention, since a first extruding means, provided at a rear end portion of the diameter widening center pin, which presses the diameter widening center pin toward a front end inner circumferential portion of the hollow die pin, and a second extruding means, which slides the blind groove forming punch onto the diameter widening center pin to press only the blind groove forming punch toward the other end of the cylindrical steel member, are respectively, individually, extrudably provided, in addition to the above-described effects, the individual second extruding means pushes the other end of a cylindrical steel member into a blind groove forming die through a blind groove forming punch without cooperating with the first extruding means in a reliably pressed state. Thus in the present invention the blind grooves for oil reservoirs can be provided with higher accuracy in a direction of a circumferential surface side bus line of the cylindrical steel member as compared with conventional blind groove forming punch and diameter widening center pin.

### BRIEF DESCRIPTION OF THE DRAWINGS

FIG. 1 is a perspective view of a bushing with blind grooves used as oil reservoirs for a chain produced according to the present invention;

FIG. 2 is a front view of a circular column-shaped blank used in an example of the present invention;

FIG. 3(a) is an explanatory view of an upsetting step in an example of the present invention, and FIG. 3(b) is a view of the product of the step in FIG. 3(a);

FIG. 4(a) is an explanatory view of a centering step in an example of the present invention, and FIG. 4(b) is a view of the product of the step in FIG. 4(a);

FIG. 5(a) is an explanatory view of a first extruding step in an example of the present invention, and FIG. 5(b) is a view of the product of the step in FIG. 5(a);

FIG. 6(a) is an explanatory view of a second extruding step in an example of the present invention, and FIG. 6(b) is a view of the product of the step in FIG. 6(a);

FIG. 7(a) is an explanatory view of a bottom removing step in an example of the present invention, and FIG. 7(b) is a view of the product of the step in FIG. 7(a);

FIG. 8 is a fragmentary perspective view of a hollow die pin and a diameter widening center pin used in an example of the present invention.

FIGS. 9(a) through 9(e) are explanatory views of a groove forming steps in an example of the present invention.

FIG. 10(a) is an explanatory view of a straightening step in an example of the present invention, and FIG. 10(b) is a partially sectioned view of the product of the step in FIG. 10(a);

FIG. 11 is a fragmentary perspective view of a hollow die pin and a diameter widening center pin used in a conventional example.

FIGS. 12(a) through 12(e) are explanatory views of groove forming steps in a conventional example.

### DESCRIPTION OF THE PREFERRED EMBODIMENTS

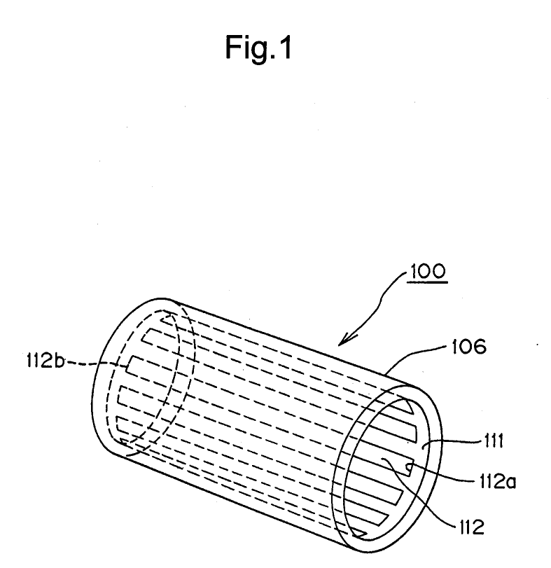

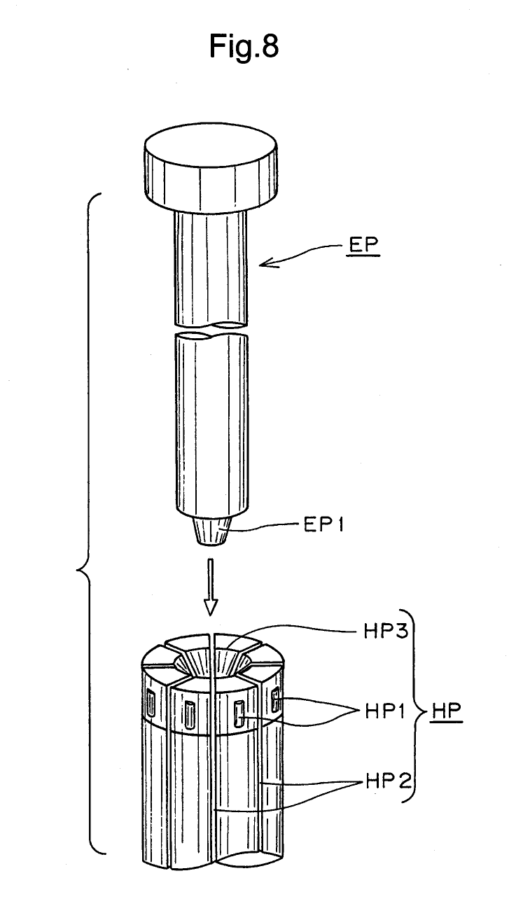

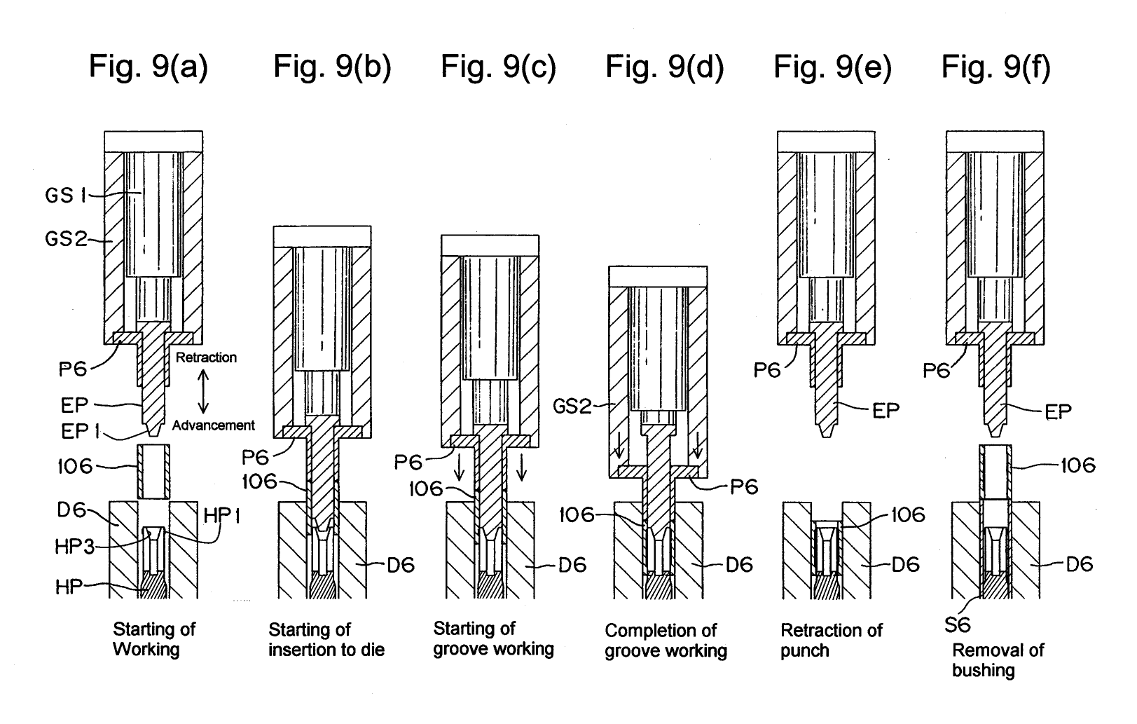

First, in the bushing 100 with blind grooves used as oil reservoirs for a chain made according to the present invention, as shown in FIG. 1, a number of blind grooves 112 as oil reservoirs are formed on the inner circumferential surface 111 of seamless cylindrical steel member 106 by use of a hollow die pin HP and a diameter widening center pin EP (FIGS. 8 and 9) which are displaced relative to the surface 111 in the axial direction of a circumferential surface bus line. Each of these blind grooves 112 as oil reservoirs has a groove form with the proximal end portion 112a and the distal end portion 112b of the blind grooves 112 and provides a sealed oil reservoir.

Therefore, the blind grooves 112, obtained by the present invention, when used as oil reservoirs, are open only the inner circumferential surface 111 of the cylindrical steel member 106 and are closed by the connecting pin when the chain is assembled. Thus, lubricating oil in the blind grooves 112 used as oil reservoirs is held without flowing out of the axial proximal end portion 112a and terminal portion 112b even in long-time use, so that excellent lubricity is maintained.

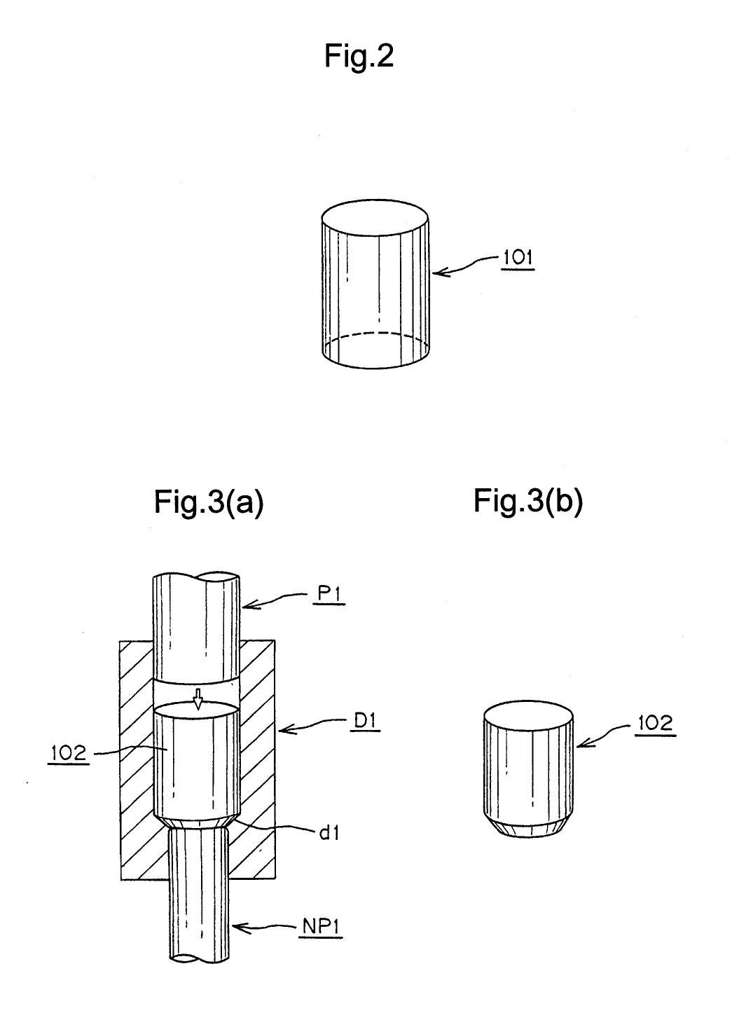

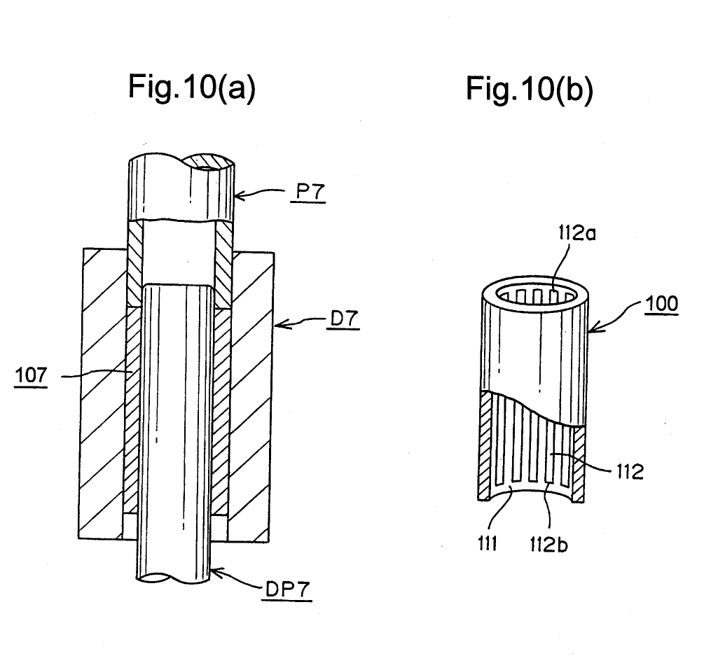

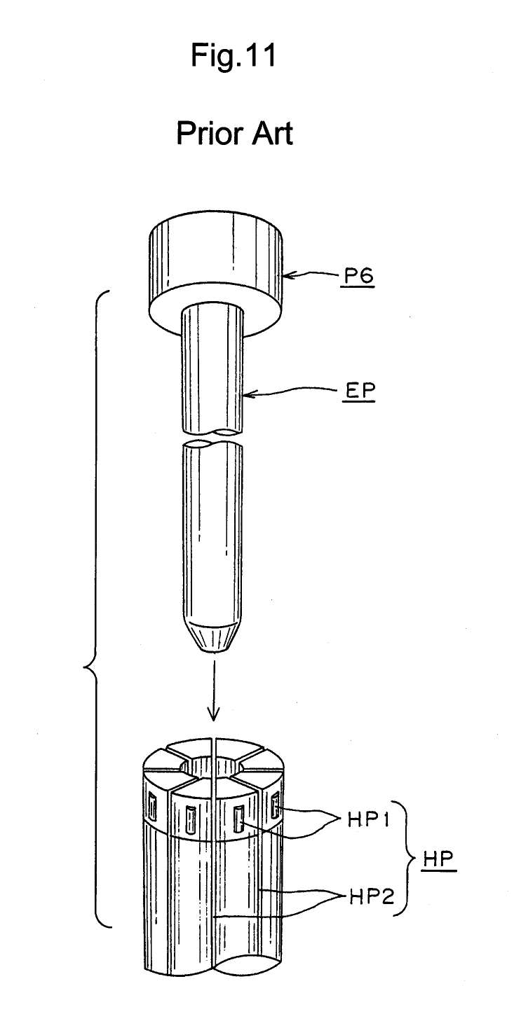

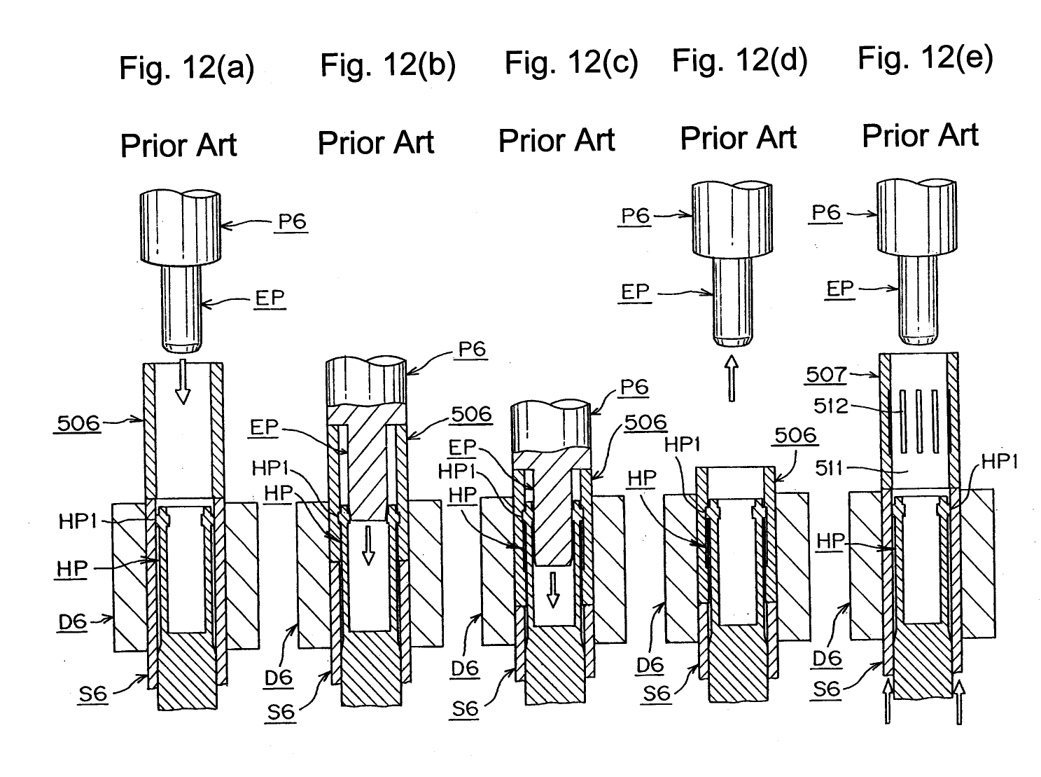

In a method according to the present invention, a circular column-shaped blank 101 obtained by cutting a steel bar to predetermined length as shown in FIG. 2 is sequentially subjected to forging processes such as an upsetting step, a centering step, a primary extrusion step, a secondary extrusion step, a bottom removing step and the like as shown in FIGS. 3 to 7, blind groove forming as shown in FIGS. 8 and 9, and straightening as shown in FIG. 10. These working steps will be described below in detail.

The circular column-shaped blank 101 obtained by cutting a steel bar to predetermined length, which is a circular column-shaped crude member as shown in FIG. 2 is pushed into a cylindrical die D1 for a blank with an inner step d1 by a punch P1 for a blank in the upsetting step as shown in FIG. 3(a), and after the upsetting, an upset circular column-shaped blank is taken out of the cylindrical die D1 for the blank by a knockout pin NP1 so that an outer circumferential surface and cut end surface-straightened cylindrical blank 102 as shown in FIG. 3(b) are obtained.

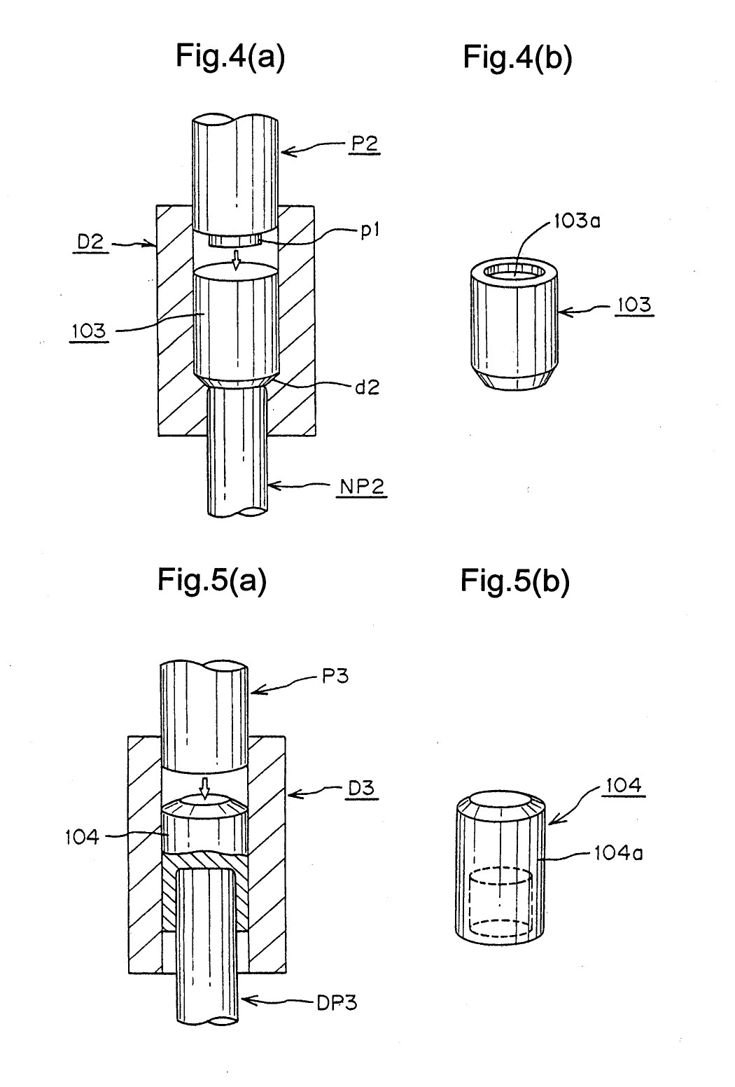

Then, in the centering step as shown in FIG. 4(a), the circular column-shaped blank 102 obtained by the above-mentioned upsetting, is pushed into a centering cylindrical die D2 with an inner step d2 by a centering punch P2 while turned upside down, and after the centering of the circular column-shaped blank 102 with a disk-shaped protrusion p1 of a centering punch P2 is completed, an upset circular column-shaped blank is taken out of the centering cylindrical die D2 by a knockout pin NP2 so that a circular column-shaped steel member 103 with a concave portion on a proximal end surface of which a concave portion 103a is formed as shown in FIG. 4(a) is obtained.

Then, in the primary extrusion step as shown in FIG. 5(a), with the steel member turned upside down, the distal end of the circular column-shaped steel member 103 with the concave portion obtained by the above-mentioned centering is again pushed into an extruding cylindrical die D3 by an extruding punch P3, and is subjected to a primary extrusion in a state where it abuts on a die pin DP3 fixed to the inside of the extruding cylindrical die D3, so that a cylindrical steel member 104 with a thick bottom in which a bottom portion 104a of thick wall as shown in FIG. 5(b) is formed, is obtained.

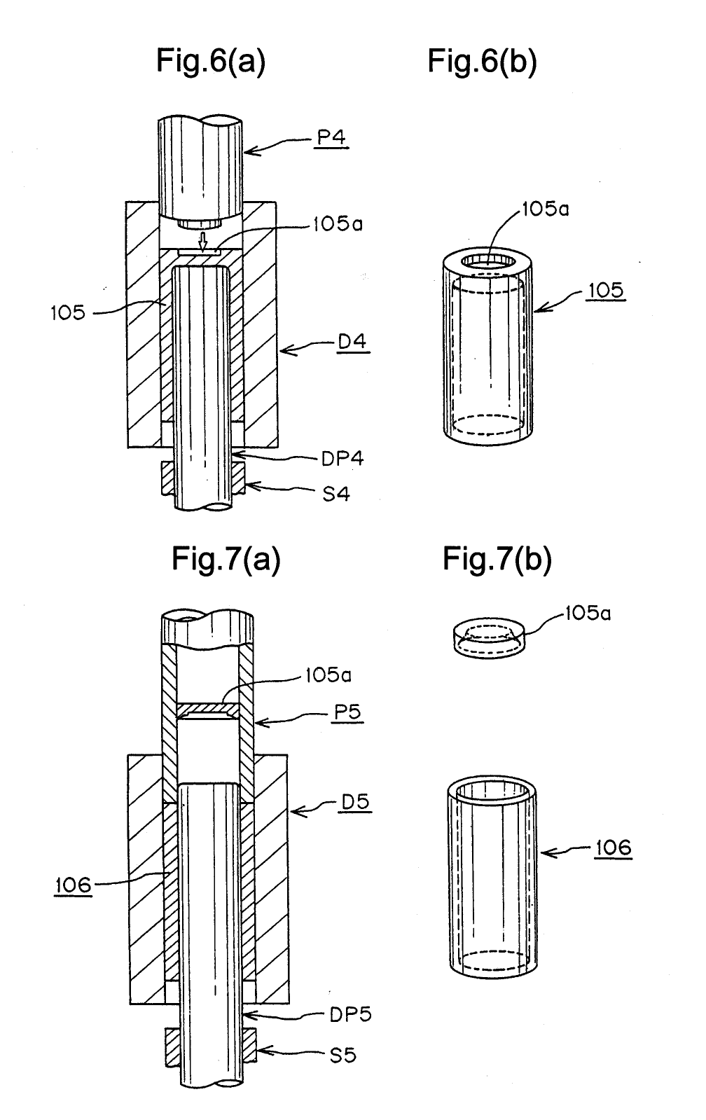

Further, in a secondary extrusion step as shown in FIG. 6(a), the cylindrical steel member 104 with a thick bottom obtained by the above-mentioned primary extrusion is pushed into an extruding die D4 by an extruding punch P4 and is subjected to the secondary extrusion while the cylindrical steel member 104 is brought into contact with an extruding die pin DP4 fixed to the inside of the extruding cylindrical die D4. After that the secondary extruded cylindrical steel member 104 is taken out of the extruding cylindrical die D4 and a cylindrical steel member 105 with a thin bottom in which a thin wall bottom portion 105a is formed as shown in FIG. 6(b) is obtained.

Then, in the bottom removing step as shown in FIG. 7(a), the cylindrical steel member 105 with thin bottom obtained by the above-mentioned secondary extrusion is pressed into a bottom removing cylindrical die D5 by a bottom removing punch P5 while turned upside down again. And while the cylindrical steel member 105 with thin bottom is brought into contact with the bottom removing die pin DP5 fixed to the inside of the bottom removing cylindrical die D5 a thin wall bottom portion 105a is removed by bottom removing. After that, the cylindrical steel member 105 is removed from the bottom removing cylindrical die D5 by a stripper S5 to obtain a shaped seamless cylindrical steel member 106 line with both ends open as shown in FIG. 7(b).

The steps for obtaining the cylindrical steel member 106 seamless in the bus line with both ends opened are not limited to the above-mentioned steps. Any manufacturing steps can be adopted if the shaped seamless cylindrical steel member 106 with both ends opened can be manufactured.

Next, the shaped seamless cylindrical steel member 106 subjected to forging processes such as the above-mentioned upsetting step, centering step, primary extrusion step, secondary extrusion step, and the like is subjected to a blind groove forming step, which a feature of the present invention as shown in FIGS. 8 and 9.

Here, the main tools used in the above-mentioned blind groove forming include, as shown in FIGS. 8 and 9, a die pin HP having a hollow front end with a number of blind groove forming protrusions HP1 on outer circumferential portions and provided with a plurality of diameter widening slits HP2 along an axial direction of the pin to provide radially-displaceable segments, a diameter widening center pin EP, which displaces the segments to diameter-widen the front end outer circumferential portion of the hollow die pin HP, a blind groove forming punch P6, loosely coaxially fitted onto this diameter widening center pin EP, which relatively slides in the axial direction of the pin, and a blind groove forming cylindrical die D6, which receives the blind groove forming punch P6.

These diameter widening center pin EP and hollow-ended die pin HP each have substantially the same outer diameter. And the diameter widening center pin EP includes a die pin engaging convex portion EP1, which is inserted into a front end inner circumferential portion HP3 of the hollow die pin HP in a wedge shape to be engaged therewith, so that it diameter widens the hollow-ended die pin HP.

Further, at the rear end portion of the diameter widening center pin EP is provided a first extruding means GS1 composed of a gas spring or the like, which presses the die pin engaging convex portion EP1 of the diameter widening center pin EP against the front end inner circumferential portion HP3 of the hollow die pin HP.

A second extruding means GS2 composed of a movable press arm or the like, displaces the above-mentioned blind groove forming punch P6 with respect to the diameter widening center pin EP so that only the blind groove forming punch P6 is pressed against the distal end of the cylindrical steel member 106, is provided so as to be able to press it individually.

The blind groove forming steps as shown in FIGS. 9(a) to 9(f) will be described below in detail.

First, as shown in FIG. 9(a), the seamless cylindrical steel member 106 obtained by the above-mentioned bottom removing step is disposed between the blind groove forming cylindrical die D6 containing the hollow die pin HP and the diameter widening center pin EP.

As shown in FIG. 9(b), when the blind groove forming punch P6 is integrally advanced by the first extruding means GS1 through the diameter widening center pin EP, this blind groove forming punch P6 abuts on and advances the cylindrical steel member 106, to push it into the blind groove forming cylindrical die D6. The proximal end of the cylindrical steel member 106 surrounds the groove forming protrusions HP1 of the hollow die pin HP contained in and fixed to the blind groove forming cylindrical die D6. That is, the groove forming protrusion HP1 of the hollow die pin HP is inserted onto an inner circumferential surface of the cylindrical steel member 106 and around the end of the die pin HP. As shown, the center pin EP passes through the distal end of the cylinder and terminates short of the proximal end.

Then, as shown in FIG. 9(c), when the blind groove forming punch P6 and pin EP are further advanced by the first extruding means GS1, the die pin engaging convex portion EP1 of the diameter widening center pin EP 106 is inserted into the hollow front end inner circumferential portion HP 3 of the hollow die pin HP and is pushed further into the inner circumferential portion HP 3 in a wedge shape so that the die pin engaging convex portion EP1 diameter-widens the hollow die pin HP and the groove forming protrusion HP1 is pressed onto the inner circumferential surface 111 of the cylindrical steel member 106 at a short distance from the proximal end.

As shown in FIG. 9(d), the above-mentioned cylindrical steel member 106 is pushed further into the groove forming die D6 through the second extruding means GS2 by the groove forming punch P6 and slides along the die pin EP while the engaging convex portion EP1 diameter-widens the hollow die pin HP. As the member 106 is displaced, the groove-forming protrusion HP1 is relatively slid with respect to the inner circumferential surface 111 of the cylindrical steel member whereby axial blind grooves 112 used as the oil reservoirs each having a semicircular cross section are formed in the inner circumferential surface, i.e., the groove forming is performed.

At this time since the die pin engaging convex portion EP1 of the diameter widening center pin EP is engaged with the front end inner circumferential portion HP3 of the hollow die pin HP to diameter-widen the hollow die pin HP, the diameter widening center pin EP can remarkably reduce diameter widening force necessary for diameter widening the front end inner circumferential portion HP3 of the hollow end of the die pin HP and at the same time the front end inner circumferential portion HP3 of the hollow die pin HP can be reliably held in a diameter widened state.

After that, as shown in FIG. 9(e), when the groove forming punch P6 is retracted, the diameter widening center pin EP is retracted so as to be removed from the cylindrical steel member 106. And the front end inner circumferential portion HP of the hollow die pin HP is diameter reduced to the original state.

Then, as shown in FIG. 9(f), when the stripper S6 is advanced, the cylindrical steel member 106 is removed from the groove forming cylindrical die D6 and the hollow die pin HP. In other words, the hollow die pin HP is relatively removed from the cylindrical steel member 106 so that a cylindrical steel member 107 which consists of the cylindrical steel member 106 in which a plurality of blind grooves 112 used as oil reservoirs are provided on the inner circumferential surface 111 is obtained.

The cylindrical steel member with blind grooves 107 which was subjected to the above-mentioned blind groove forming is turned upside down again, and is pushed into a straightening cylindrical die D7 by a straightening punch 7 in a straightening step as shown in FIG. 10, so that straightening of the cylindrical steel member 107 is performed on the inner and outer circumferential surfaces while being abutted on the straightening cylindrical die D7 fixed to the inside of the straightening cylindrical die D7. As the result, as shown in FIG. 10(b), a bushing 100 with blind grooves as oil reservoirs for a chain, including a plurality of blind grooves 112 used as oil reservoirs as shown in FIG. 1 on the inner circumferential surface 111, is obtained.

According to the above-mentioned method of making a bushing 100 with blind grooves used as oil reservoirs for a chain, which is an example of the present invention, when blind grooves 112 used as oil reservoirs are provided on an inner circumferential surface of the cylindrical steel member 106, the diameter widening center pin EP and the hollow die pin HP are not slid unlike the conventional case and the diameter widening center pin EP is inserted into a front end inner circumferential portion HP3 of the hollow die pin HP and is held in an abutted state. Therefore, wear damages of the diameter widening center pin EP and the hollow die pin HP for a long period of time are suppressed so that excellent fatigue strength can be exhibited and blind grooves 112 used as oil reservoirs can be provided with high accuracy.

Further, since the diameter widening center pin EP is inserted as a wedge, so that diameter widening force upon the diameter widening of the front end inner circumferential portion HP3 of the hollow die pin HP is remarkably reduced and a front inner circumferential portion HP3 of the hollow die pin HP is reliably held while it is diameter-widened, severe metal fatigue due to a diameter widening operation, which is repeated in the entire area of hollow portions of the hollow die pin, can be avoided unlike the conventional case and the diameter widening center pin EP and the hollow die pin HP each have higher strength and a pin shape of a larger diameter than the conventional case. Thus the long lives of the diameter widening center pin EP and the hollow die pin HP can be attained.

Further, since the individual second extruding means pushes the other end of a cylindrical steel member 106 into a blind groove forming die D6 through a blind groove forming punch P6 without cooperating with the first extruding means in a reliably pressed state, according to the present invention, blind grooves used as oil reservoirs can be provided with higher accuracy in a direction of a circumferential surface side bus line of the cylindrical steel member 106 as compared with a conventional case in which while diameter widening by use of tools such as a blind groove forming punch P6 and a diameter widening center pin EP an end of the cylindrical steel member is pressed so that blind grooves used as oil reservoirs are provided. Thus the effects of the present invention are very large.

1. A method of making a bushing with blind grooves used as oil reservoirs for a chain, by which a plurality of blind grooves for oil reservoirs are formed on an inner circumferential surface of a cylindrical steel member in an axial direction by forging steps using at least a die pin having a hollow front end portion with a number of blind-groove-forming protrusions on the outer circumferential portion and a plurality of diameter widening slits along the axial direction of the pin providing radially-displaceable segments, a diameter widening center pin operable top displace said segments radially outward of said hollow die pin and diameter widen the outer diameter of the hollow front end portion, a blind groove forming punch concentrically loosely surrounding said diameter widening center pin and operable to slide in the longitudinal direction relative to the pin, and a blind groove forming die to receive said blind groove forming punch, comprising the steps of:
providing a seamless hollow cylindrical steel member having a proximal end and a distal end,
engaging the proximal end of said cylindrical steel member over said groove forming protrusions of said hollow die pin contained in said blind groove forming die,
positioning the blind groove forming protrusions of said hollow die pin against an inner circumferential surface of the cylindrical steel member adjacent said proximal end, and inserting said diameter widening center pin through the distal end of said cylindrical steel member and into said hollow front end inner of said die pin to displace the segments radially outward to press said protrusions into the inner surface of said cylindrical steel member, and
then forming a number of axial blind grooves for oil reservoirs in said cylinder by axially displacing the cylinder relative to said blind groove forming punch and into said blind groove forming die from the distal end of said cylindrical steel member to cause the protrusions to slide along the inner circumferential surface of said cylindrical steel member.

2. A method of making a bushing with blind grooves used as oil reservoirs for a chain according to claim 1, characterized in that said diameter widening center pin includes a die pin engaging convex portion in a wedge shape, and including the step of inserting said convex portion into the hollow front end of said die pin to engage and diameter widen said hollow end of the die pin.

3. A method of making a bushing with blind grooves used as oil reservoirs for a chain according to claim 1, using a first extruding means provided at a rear end portion of said diameter widening center pin, including the step of pressing the diameter widening center pin into the inner circumferential portion of the hollow end of the die pin, and using a second extruding means to slide the cylindrical member along the protrusions of said blind groove forming punch press toward the other end of said cylindrical steel member, to produce said blind grooves.

4. A method fo making a bushing according to claim 1, wherein said step of providing a seamless hollow cylindrical steel member comprises the preliminary steps of providing a steel bar to a predetermined length, pressing the bar into a hollow cylindrical die to form a blank, cutting the ends of the blank to produce a cut-ended surface-straightened cylindrical blank having proximal and distal ends, punching a concave portion into the proximal end of said blank, extruding the distal end of said blank to produce a blank having a hollow cylindrical portion at the distal end, and a solid cylindrical portion forming a bottom with an exposed concave portion at the proximal end, and removing said bottom to produce the seamless hollow cylindrical steel member having open proximal and distal ends.
